(19) United States
(12) Patent Application Publication
(10) Pub. No.: US 2011/0096372 A1
(43) Pub. Date: Apr. 28, 2011

(54) HEND-HELD DEVICE FOR SCANNING AND TRANSFERRING INTO A COMPUTER APPLICATION

(75) Inventor: Kevin M. Crucs, Copley, OH (US)

(73) Assignee: CRUCS HOLDINGS, LLC, Copley, OH (US)

(21) Appl. No.: 12/691,099

(22) Filed: Jan. 21, 2010

Related U.S. Application Data
(63) Continuation-in-part of application No. 12/606,292, filed on Oct. 27, 2009.

(51) Int. Cl. H04N 1/04

(52) U.S. Cl. 358/474

(57) ABSTRACT

A hand-held device for scanning and subsequent transferring. The hand-held device has an optical scanning head integrated at a proximal end portion of a housing of the device, and a data transfer interface component integrated within the housing of the device. Displayed, printed, or written information may be read from a scannable medium by manually moving (or fixedly positioning) a proximal end of the hand-held device across (or on) the scannable medium over the information. The read information is electronically stored within the hand-held device, and the stored information may be transferred into a data field, selected by a user of the hand-held device, of a software application running on a separate processor-based apparatus.

This U.S. Patent Application is a continuation-in-part (CIP) of and claims priority to U.S. patent application Ser. No. 12/606,292 filed on Oct. 27, 2009 and which is incorporated by reference herein in its entirety.

### TECHNICAL FIELD

Certain embodiments of the present invention relate to hand-held devices. More particularly, certain embodiments relate to hand-held devices for scanning and transferring into a computer program.

### BACKGROUND

Currently, if a user tries to transfer information, such as a person's name in a medical record or an excerpt from a book, into a data field of a software application program, the user has to physically type the information into a selected data field. This process of reading or receiving information and then typing it into a software application program is very time consuming and prone to include errors, such as misspelled words.

Further limitations and disadvantages of conventional, traditional, and proposed approaches will become apparent to one of skill in the art, through comparison of such approaches with the subject matter of the present application as set forth in the remainder of the present application with reference to the drawings.

### SUMMARY

An embodiment of the present invention comprises a hand-held device for scanning and subsequent transfer. The hand-held device includes an elongated housing having a proximal end portion and a distal end portion and capable of being gripped by a hand of a user. The device further includes a microprocessor and associated support circuitry physically integrated into an interior volume of the housing. The device also includes an optical scanning head physically integrated into the proximal end portion of the housing and operatively connected to the microprocessor and associated support circuitry. The device further includes a data transfer interface component physically integrated into the interior volume of the housing and operatively connected to the microprocessor and associated support circuitry. The device also includes an electronic storage memory physically integrated into an interior volume of the housing and operatively connected to the microprocessor and associated support circuitry. The hand-held device may further include a power source physically integrated into an interior volume of the housing and operatively connected to various elements of the hand-held device to provide electrical power to various elements of the hand-held device. The device may also include at least one motion sensor operatively connected to the microprocessor and associated support circuitry. The motion sensor may include an accelerometer physically integrated into an interior volume of the housing or a position wheel physically integrated at the proximal end portion of the housing. The hand-held device may further include a display physically integrated into a side portion of the housing and operatively connected to the microprocessor and associated support circuitry. The optical scanning head may include a photosensor array and the photosensor array may be a multiple color detection elevated pin photo diode active pixel sensor. The power source may include a re-chargeable power pack capable of operatively interfacing with an external power charger. The power source may instead include at least one replaceable battery. The hand-held device may further include a light source physically integrated at the proximal end portion of the housing and operatively connected to the microprocessor and associated support circuitry. The light source may include a light emitting diode. The hand-held device may also include a proximal activation interface operatively connected to the microprocessor and associated support circuitry and capable of activating the optical scanning head when engaged by a user and de-activating the optical scanning head when disengaged by the user. The data transfer interface component may include a wired connector and the wired connector may be a universal serial bus connector port. The data transfer interface component may instead include a wireless interfacing circuit where the wireless interfacing circuit is capable of transmitting a short range radio transmission for data transfer. The hand-held device may be capable of interacting with a touchscreen surface. Interacting with a touchscreen surface may include transmitting scanned information into a data field selected by the hand-held device. Alternatively, interacting with a touchscreen surface may include the automatic transmission of scanned information into a data field selected by the hand-held device as the information is scanned. The data transfer interface component may automatically transmit scanned information immediately after the optical scanning head is deactivated by a user. The hand-held device may further include a distal activation button that is physically integrated into a side portion of the housing and operatively connected to the microprocessor and associated support circuitry and is capable of activating the data transfer interface component when engaged by a user and de-activating the data transfer interface component when disengaged by the user. The distal activation button may initiate transmission of scanned information to a data field selected by a user. The data field selected by a user may include a data field in which a cursor is positioned.

Another embodiment of the present invention comprises a hand-held apparatus capable of being gripped by a hand of a user. The apparatus includes means for reading displayed, printed, or written information from a scannable medium in response to manually moving a proximal end of the hand-held apparatus across the scannable medium over the information. The apparatus further includes means for storing the read information in the hand-held apparatus and means for transferring the stored information into a data field of a software application program running on a processor-based apparatus in response to pressing a distal activation button. The hand-held apparatus may further include means for activating and means for de-activating the means for reading. The hand-held apparatus may further include means for illuminating the scannable medium and means for activating and means for de-activating the means for reading and means for illuminating. The hand-held apparatus may also include means for activating and means for de-activating the means for transferring. The hand-held apparatus may further include at least one of means for displaying the stored information on the hand-held apparatus, means for electronically charging the hand-held apparatus, means for replacing at least one power source of the hand-held apparatus, and means for connecting the hand-held apparatus to an external power source. The hand-held apparatus may also include means for processing the read information to motion compensate and stitch together successive captured frames of the read information. The hand-held apparatus may further include means for processing the read information to perform an optical character reading operation on the read information to form optically character read information. The hand-held apparatus may also include means for changing a font and size of the optically character read information.

A further embodiment of the present invention comprises a hand-held apparatus capable of being gripped by a hand of a user. The apparatus includes means for reading displayed, printed, or written information from a scannable medium in response to manually positioning a proximal end of the hand-held apparatus over the information on the scannable medium at a fixed position. The apparatus further includes means for storing the read information in the hand-held apparatus, and means for transferring the stored information into a data field of a software application program running on a processor-based apparatus in response to manually positioning a distal end of the hand-held apparatus onto a touchscreen surface in association with the processor-based apparatus at a fixed position corresponding to the data field. The hand-held apparatus may further include means for activating and means for de-activating the means for reading. The hand-held apparatus may also include means for illuminating the scannable medium and means for activating and de-activating the means for reading and the means for illuminating. The hand-held apparatus may further include means for activating and means for de-activating the means for transferring. The hand-held apparatus may also include at least one of means for displaying the stored information on the hand-held apparatus, means for electronically charging the hand-held apparatus, means for replacing at least one power source of the hand-held apparatus, and means for connecting the hand-held apparatus to an external electrical power source. The hand-held apparatus may further include means for processing the read information to perform an optical character reading operation on the read information to form optically character read information and means for changing a font and size of the optically character read information.

These and other novel features of the subject matter of the present application, as well as details of illustrated embodiments thereof, will be more fully understood from the following description and drawings.

### BRIEF DESCRIPTION OF THE DRAWINGS

FIG. 1 illustrates a schematic block diagram of an embodiment of a hand-held device for scanning and subsequent printing;

FIG. 2 illustrates a top view of a first example embodiment of a housing of the hand-held device of FIG. 1 and showing various elements or components integrated therewith;

FIG. 3 illustrates a side view of the first example embodiment of the housing of the hand-held device of FIG. 1 and FIG. 2 showing various integrated elements and components that are at least partially visible on the outside of the housing;

FIG. 4 illustrates a perspective view of the hand-held device of FIG. 3 being held by a user's hand;

FIG. 5 is a flowchart of an embodiment of a method of using the hand-held device of FIG. 1 and FIG. 4;

FIG. 6 illustrates a top view of a second example embodiment of a housing of a hand-held device, and showing various elements or components integrated therewith;

FIG. 7 illustrates a side view of the second example embodiment of the housing of the hand-held device of FIG. 6, and showing various integrated elements and components that are at least partially visible on the outside of the housing;

FIG. 8 illustrates a top view of a third example embodiment of a housing of a hand-held device, and showing various elements or components integrated therewith;

FIG. 9 illustrates an example of a printed image resulting from multiple printing passes, in accordance with an embodiment of the present invention;

FIG. 10 illustrates an example of a portion of a printed image resulting from one or more printing passes and leaving a printed marker for a next printing pass, in accordance with an embodiment of the present invention;

FIG. 11 illustrates a schematic block diagram of an embodiment of a hand-held device for scanning and subsequent data transfer;

FIG. 12 illustrates a top view of a first example embodiment of a housing of the hand-held device of FIG. 11 and showing various elements or components integrated therewith;

FIG. 13 illustrates a side view of the first example embodiment of the housing of the hand-held device of FIG. 11 and FIG. 12 showing various integrated elements and components that are at least partially visible on the outside of the housing;

FIG. 14 illustrates a perspective view of the hand-held device of FIG. 13 being held by a user's hand;

FIG. 15 is a flowchart of an embodiment of a method of using the hand-held device of FIG. 11 and FIG. 14; and

FIG. 16 illustrates a view of an embodiment of a hand-held device interfacing to a personal computer.

### DETAILED DESCRIPTION

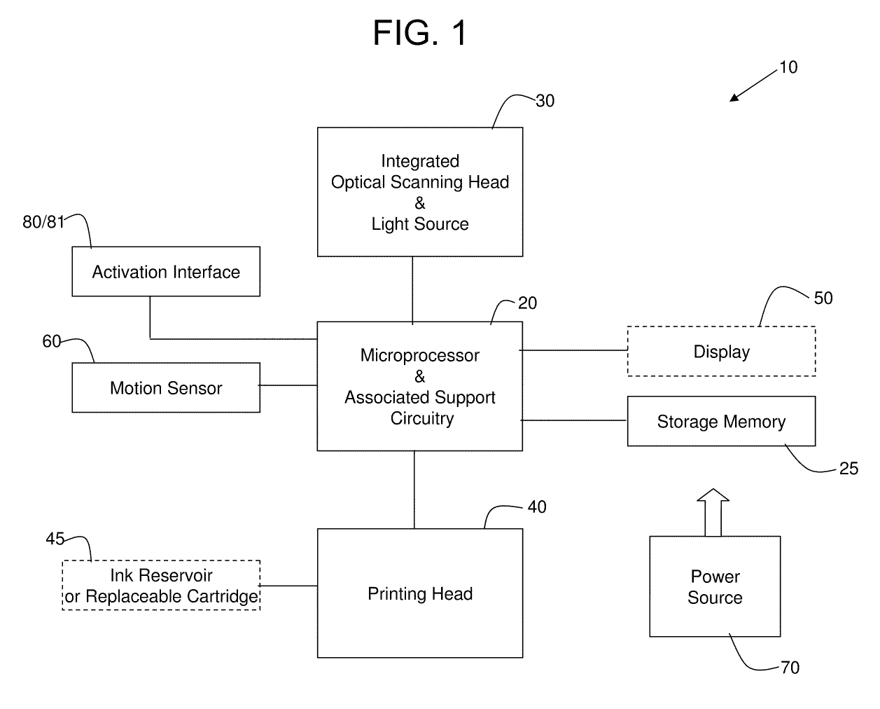

FIG. 1 illustrates a schematic block diagram of an embodiment of a hand-held device 10 for scanning and subsequent printing. The device 10 is used to scan displayed, printed, or written information from a scannable medium such as, for example, a computer screen or a page in a book, and then subsequently print the scanned information onto a printable medium such as, for example, a page in a bound notebook using the same device 10. As another example, the device 10 may be used by an individual to scan his or her signature, and then subsequently used to print the scanned signature on a plurality of documents to be signed by the individual. The device 10 is capable of being held or gripped by a hand of a user. In certain embodiments, the device is capable of being gripped by a hand of a user in a manner similar to that of gripping a writing utensil. In accordance with an embodiment of the present invention, the device 10 is held and moved in a manner similar to how a hi-liter marker is held and moved.

The device 10 includes a microprocessor and associated support circuitry 20. The associated support circuitry portion of the microprocessor and associated support circuitry 20 may include, for example, display driver circuitry, user interface circuitry, control interface circuitry, a printed circuit board, and connecting wires, in accordance with various embodiments of the present invention. The device 10 includes an optical scanning head 30 or, alternatively, an integrated optical scanning head and light source 30, operatively connected to the microprocessor and associated support circuitry 20. The device 10 further includes a printing head 40 operatively connected to the microprocessor and associated support circuitry 20. The device 10 also includes a storage memory 25, a motion sensor 60, and an activation interface 80/81 each operatively connected to the microprocessor and associated support circuitry 20. The device 10 further includes an electrical power source 70. As an option, the device 10 may include an ink reservoir or replaceable ink cartridge 45. As a further option, the device 10 may include a display 50 (e.g., a liquid crystal display (LCD)).

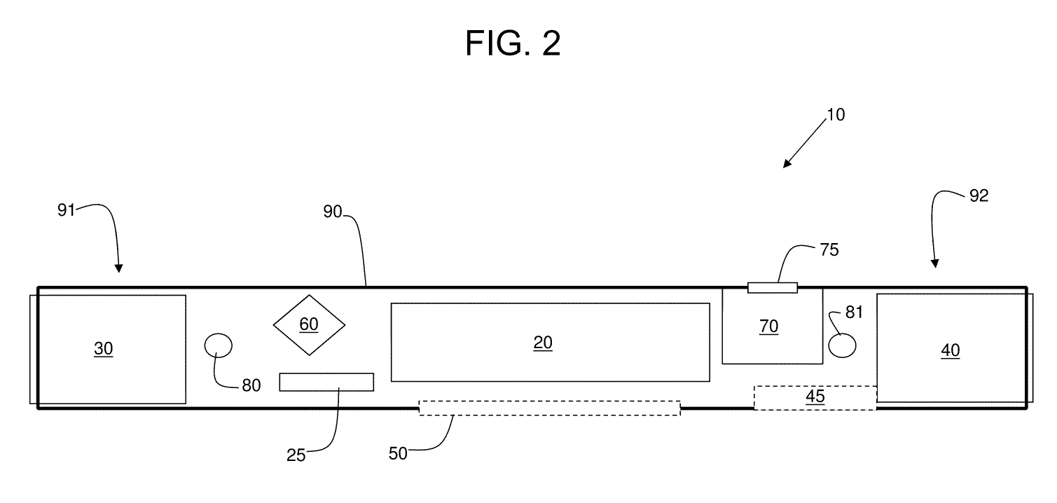

FIG. 2 illustrates a top view of a first example embodiment of a housing 90 of the hand-held device 10 of FIG. 1 and showing various elements or components integrated therewith. In accordance with an embodiment of the present invention, the housing 90 is elongated and is substantially cylindrical in shape. In accordance with another embodiment of the present invention, the housing 90 is elongated and substantially rectangular in shape (e.g., a rectangular cuboid). The optical scanning head 30 is physically integrated into a proximal end portion 91 of the housing 90, and the printing head 40 is physically integrated into a distal end portion 92 of the housing 90.

The microprocessor and associated support circuitry 20 is physically integrated into an interior volume of the housing 90. Similarly, the motion sensor 60 is physically integrated into an interior volume of the housing 90. In accordance with an embodiment of the present invention, the motion sensor 60 includes an accelerometer. The electronic storage memory 25 is physically integrated into an interior volume of the housing 90. The display 50 is physically integrated into a side portion of the housing 90 and is operatively connected to the microprocessor and associated support circuitry 20. The display 50 is shown in dotted line to indicate that it is optional.

The power source 70 is physically integrated into an interior volume of the housing 90 and is operatively connected to various elements and components (e.g., the microprocessor and associated support circuitry 20, the optical scanning head 30, the printing head 40, the storage memory 25, the motion sensor 60, and the display 50) of the hand-held device 10 to provide electrical power to those various elements and components. In accordance with an embodiment of the present invention, the power source 70 includes a re-chargeable power pack having an electrical connector interface 75 allowing the power source 70 to be operatively connected to an external power charger. In accordance with another embodiment of the present invention, the power source 70 includes at least one replaceable battery. In accordance with still another alternative embodiment of the present invention, a power source 70 is not provided within the housing 90 and, instead, the device 10 is capable of being plugged into an external electrical power source during use.

The printing head 40 is an inkjet print cartridge, in accordance with an embodiment of the present invention, and uses a supply of ink for printing onto a printable medium. The supply of ink may be in the form of a refillable ink reservoir or a replaceable ink cartridge, both represented by the reference numeral 45 in the drawings. The refillable ink reservoir 45 is physically integrated into an interior volume of the housing 90 and is operatively connected to the printing head 40 (e.g., by a tube or hose) to provide ink thereto. Alternatively, the replaceable ink cartridge 45 is capable of being physically inserted into a side portion of the housing 90 and is operatively connected to the printing head 40 upon being inserted. In accordance with another alternative embodiment of the present invention, the printing head 40 is a laser print cartridge including associated toner and roller components. In such another alternative embodiment, the refillable ink reservoir or replaceable ink cartridge 45 is not used and is, therefore, shown in dotted line in the figures as being optional.

The optical scanning head 30 includes a photosensor array which is a multiple color detection elevated pin photo diode active pixel sensor, in accordance with an embodiment of the present invention. In accordance with an alternative embodiment of the present invention, the photosensor array is a gray-scale detection elevated pin photo diode active pixel sensor. Other types of optical scanning heads are possible as well, in accordance with other embodiments of the present invention. The optical scanning head 30 may include an integrated light source (e.g., a light emitting diode (LED)). The light source is used to illuminate the scannable medium (e.g., a page of a book) while scanning with the optical scanning head 30. However, if the scannable medium is a fully lit computer screen, for example, the light source is not needed.

The proximal activation interface 80 is located near the proximal end portion 91 of the housing 90 on the top of the housing 90 and is capable of actiavting the optical scanning head 30 when manually engaged by a user, and de-activating the optical scanning head 30 when manually disengaged by a user. For example, the proximal activation interface 80 may be a button that, when pressed and held down by an index finger of the user, activates the optical scanning head 30 and, when released by the user, de-activates the optical scanning head 30. Similarly, the distal activation interface 81 is located near the distal end portion 92 of the housing 90 on the top of the housing 90 and is capable of activating the printing head 40 when manually engaged by a user, and de-activating the printing head 40 head when manually disengaged by a user. For example, the distal activation interface 81 may be a button that, when pressed and held down by an index finger of the user, activates the printing head 40 and, when released by the user, de-activates the printing head 40. In accordance with an alternative embodiment of the present invention, the activation interfaces 80/81 may be replaced with pressure sensitive switches integrated into the proximal and distal ends of the device 10. When the proximal end of the device 10 is pressed against a scannable medium, the optical scanning head 30 is activated. Similarly, when the distal end of the device 10 is pressed against a printable medium, the printing head 40 is activated. Pulling the proximal end or distal end of the device 10 away from the medium de-activates the corresponding head. Such an alternative embodiment provides for automatic activation/de-activation of the optical scanning head 30 and the printing head 40.

The term “activate”, as used herein with respect to certain embodiments, means to “turn on” to be ready for use. For example, in accordance with an embodiment of the present invention, activating the optical scanning head 30 turns on the optical scanning head 30 by applying electrical power to the optical scanning head 30 to ready it for scanning. However, the optical scanning head 30 does not actually begin to scan or capture information from a scannable medium until a user begins to move the device 10, in accordance with an embodiment of the present invention. Such movement is detected by the motion sensor 60, for example. Furthermore, moving the device 10 without first activating the optical scanning head 30 does not result in scanning or capturing information.

Similarly, activating the printing head 40 turns on the printing head 40 by applying electrical power to the printing head 40 to ready it for printing. However, the printing head 40 does not actually begin to print information onto a printable medium until a user begins to move the device 10, in accordance with an embodiment of the present invention. Such movement is detected by the motion sensor 60, for example. Furthermore, moving the device 10 without first activating the printing head 40 does not result in printing information. Also, the term “de-activate”, as used herein with respect to certain embodiments, means to “turn off” by, for example, disconnecting electrical power.

In accordance with certain alternative embodiments of the present invention, a motion sensor is not used to detect motion of the device 10. Instead, activation of the optical scanning head 30 via the proximal activation interface 80 directly initiates the scanning or capturing of information from a scannable medium. Furthermore, activation of the printing head 40 via the distal activation interface 81 directly initiates the printing of information onto a printable medium.

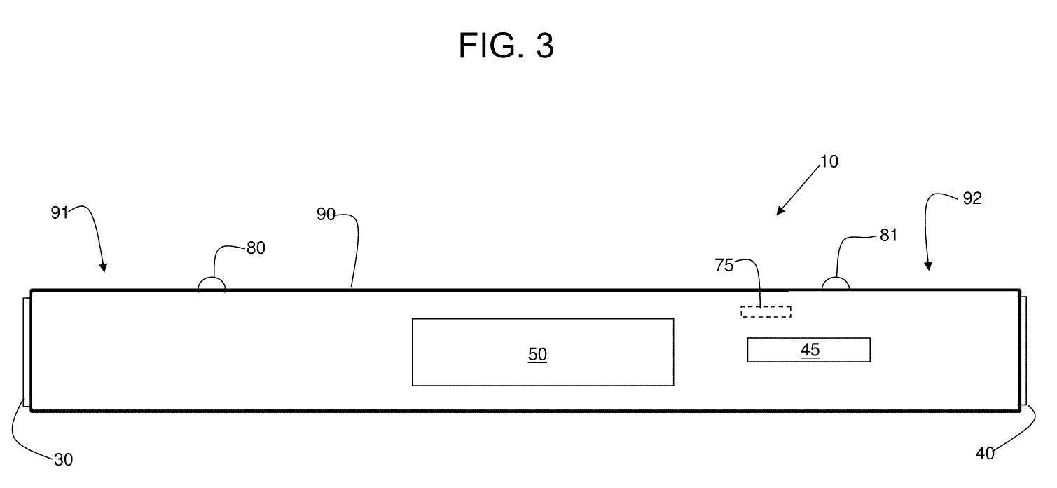

FIG. 3 illustrates a side view of the first example embodiment of the housing 90 of the hand-held device 10 of FIG. 1 and FIG. 2 showing various integrated elements and components that are at least partially visible on the outside of the housing 90. The display 50 can be seen, along with the inserted replaceable ink cartridge 45, and the activation interfaces 80 and 81. An exposed contacting portion of the optical scanning head 30 is shown, along with an exposed contacting portion of the printing head 40. The contacting portion of the optical scanning head 30 is used to make contact with, or at least closely approach, a scannable medium during operation. Similarly, the contacting portion of the printing head 40 is used to make contact with, or at least closely approach, a printable medium during operation. The electrical connector 75 is shown in dotted line as being on the other side of the housing 90 (i.e., not visible from this side).

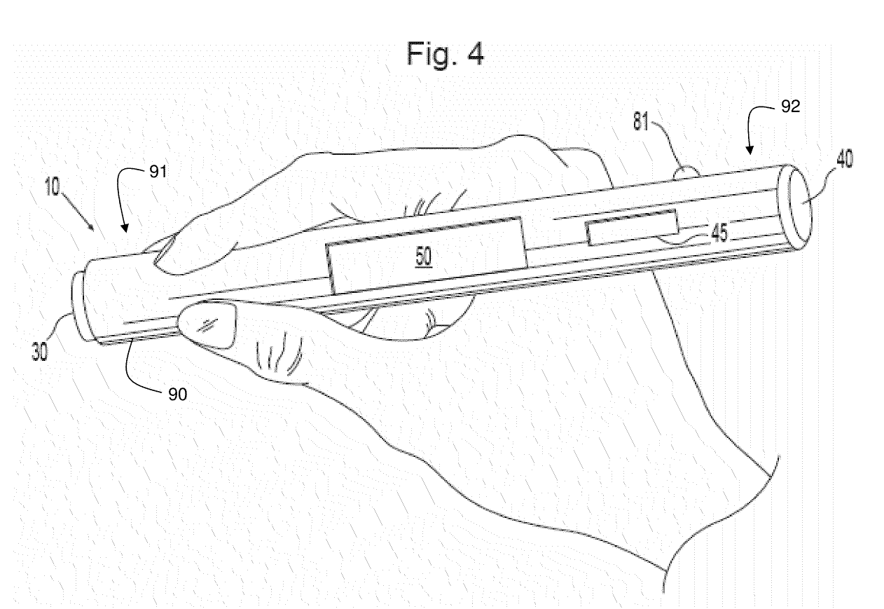

FIG. 4 illustrates a perspective view of the hand-held device 10 of FIG. 3 being held by a user's hand. The hand-held device 10 is shown as being substantially cylindrical in FIG. 4. As can be seen from FIG. 4, the hand-held device 10 is held in a manner similar to that of holding a writing utensil or a hi-liter marker. Again, the display 50 can be seen, along with the inserted replaceable ink cartridge 45. In FIG. 4, the display 50 and the inserted replaceable ink cartridge 45 are shown as being slightly recessed into the side of the housing 90. The proximal activation interface 80 is concealed by the index finger of the user's hand. However, the distal activation interface 81 is clearly shown. Again, an exposed contacting portion of the optical scanning head 30 is shown, along with an exposed contacting portion of the printing head 40. The user is holding the device 10 in FIG. 4 so as to perform a scanning operation. By rotating the device 10 around 180 degrees, the user would be holding the device so as to perform a printing operation.

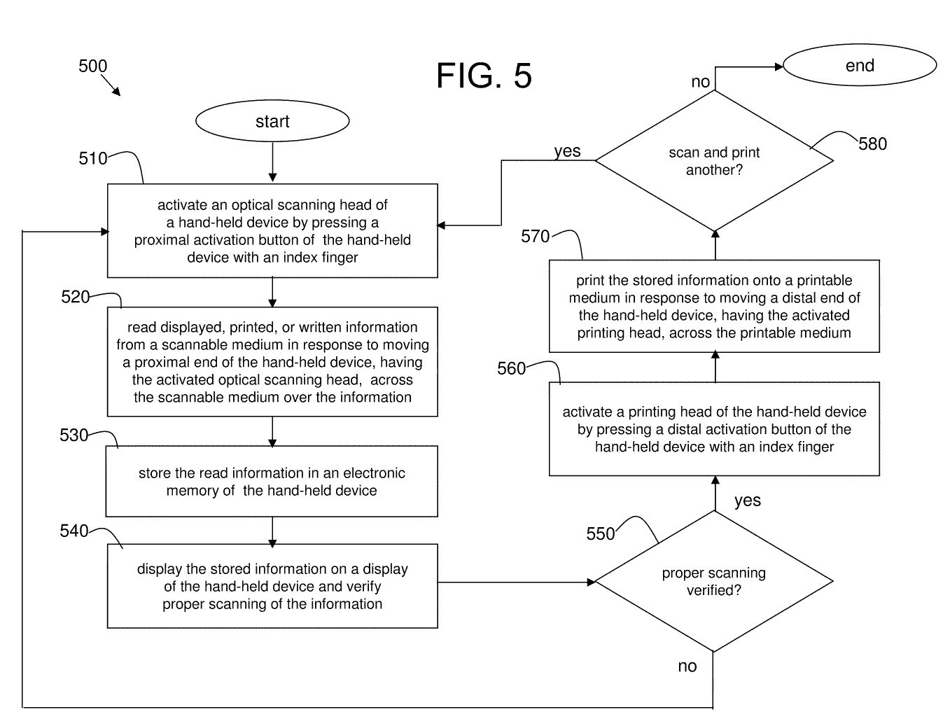

FIG. 5 is a flowchart of an embodiment of a method 500 of using the hand-held device 10 of FIG. 1 and FIG. 4. In step 510, an optical scanning head 30 of the hand-held device 10 is activated by pressing a proximal activation button 80 of the hand-held device 10 with an index finger. In step 520, information (e.g., displayed, printed, or written information) is read from a scannable medium in response to moving a proximal end 91 of the hand-held device 10, having the activated optical scanning head 30, across the scannable medium over the information. In step 530, the read information is stored in an electronic memory 25 (e.g., a random access memory (RAM)) of the hand-held device 10.

In step 540, the stored information is displayed on a display 50 of the hand-held device 10 such that the user may verify that the desired information was scanned properly from the scannable medium. In step 550, if proper scanning is verified, then go to step 560. If proper scanning is not verified, then go back to step 510 to start over. In step 560, a printing head 40 of the hand-held device 10 is activated by pressing a distal activation button 81 of the hand-held device 10 with an index finger. In step 570, the stored information is printed onto a printable medium in response to moving a distal end 92 of the hand-held device 10, having the activated printing head 40, across the printable medium. In step 580, if it is desired to scan and print another displayed, printed, or written information, then go back to step 510, otherwise, end.

As can be seen from FIG. 4 and FIG. 5, the device 10 is relatively easy to use. The device 10 is held a first way by a user to scan (i.e., read in) information, and the device is held a second way to print that information. As an example, to scan, a user positions the proximal end (having the optical scanning head 30) at the beginning of a text phrase displayed on a computer screen to be optically scanned. The user activates the optical scanning head 30 by pressing the proximal activation button 80. Then the user moves the proximal end of the device 10 across the text phrase displayed on the screen, scanning (i.e., reading in) the text phrase. The initiation of the movement of the device 10, while the proximal activation button 80 is pressed, causes the optical scanning head 30 to actively begin reading. When the user stops moving the device 10 upon reaching the end of the text phrase, the optical scanning head 30 stops reading. At this point, the user releases the proximal activation button 80 and the scanned information is stored in memory 25 and displayed on the display 50. The user may view the displayed text phrase on the display 50 to verify that the text phrase was scanned correctly. If not scanned correctly, the user may repeat the scanning process, trying to move the device 10 across the text phrase in a more accurate or uniform manner, and/or at a different speed, to facilitate proper scanning. Becoming accomplished at properly moving the hand-held device 10 to scan may take some practice on the part of the user. As used herein, the term “text” may refer to any alphabetic, numeric, or alpha-numeric combination of characters.

Continuing with the example, to print the scanned text phrase, a user positions the distal end (having the printing head 40) at the beginning of a place to print on a printable medium such as a paper page in a laboratory notebook. The user activates the printing head 40 by pressing the distal activation button 81. Then the user moves the distal end of the device 10 across the page, printing the stored text phrase. The initiation of the movement of the device 10, while the distal activation button 81 is pressed, causes the printing head 40 to actively begin printing. When the text phrase has been entirely printed, the printing head 40 stops printing. At this point, the user stops moving the device 10 and releases the distal activation button 81. The user may view the printed text phrase on the notebook page to verify that the text phrase was printed correctly. If not printed correctly, the user may repeat the printing process on a different part of the page, possibly moving the device 10 across the notebook page in a more accurate or uniform manner, and/or at a different speed, to facilitate proper printing. Becoming accomplished at properly moving the hand-held device 10 to print may take some practice on the part of the user.

The internal operation of the device 10 is performed as follows, in accordance with an embodiment of the present invention. When a user presses the proximal activation button 80, the optical scanning head 30 (and light source, if present) is activated (i.e., electrical power is provided to the optical scanning head 30). This is accomplished by sending an electrical signal from the proximal activation button 80 to the microprocessor and associated support circuitry 20. The microprocessor and associated support circuitry 20 receives and processes the signal and then switches electrical power from the power source 70 to the optical scanning head 30 in response. Next, when the user begins moving the device 10 (e.g., across a scannable medium), the motion sensor (e.g., accelerometer) senses the movement and sends an electrical signal to the microprocessor and associated support circuitry 20 in response. The electrical signal is received and processed by the microprocessor and associated support circuitry 20 which then sends another electrical signal to the optical scanning head 30 which directs the optical scanning head 30 to begin capturing (i.e., begin reading).

When the user stops moving the device 10 (e.g., across the scannable medium), the motion sensor senses the stopped motion and sends an electrical signal to the microprocessor and associated support circuitry 20 in response. The electrical signal is received and processed by the microprocessor and associated support circuitry 20 which then sends another electrical signal to the optical scanning head 30 which directs the optical scanning head 30 to stop capturing (i.e., stop reading). The user then releases the proximal activation button 80 and, upon such releasing, an electrical signal is sent from the proximal activation button 80 to the microprocessor and associated support circuitry 20. The electrical signal is received and processed by the microprocessor and associated support circuitry 20 which then, in response, receives and processes the captured information (i.e., the read data) from the optical scanning head 30, proceeds to store the processed information in the electronic storage memory 25, proceeds to send the stored information to the display 50 to display the information, and then powers down the optical scanning head 30. While still holding the device 10, the user can easily view the displayed information to verify that the desired information was properly scanned and captured. The resultant printed information, as a result of subsequent printing, will appear essentially the same as the displayed information, on a pixel-by-pixel basis.

In accordance with an embodiment of the present invention, successive frames of scanned information (acquired during the scanning process as the proximal end of the device is moved across the scannable medium) are processed by the microcontroller and associated supporting circuitry 20, before displaying, to motion compensate the successive frames and electronically “stitch” the frames together to correctly represent the information being scanned. In accordance with another embodiment of the present invention, the microcontroller and associated supporting circuitry 20 further performs an optical character reading (OCR) operation on the scanned and motion compensated information if the information is in text form. Furthermore, the font and size of the OCR'd information may be changed to that of a user-selected font and size by the microcontroller and associated supporting circuitry 20 before displaying and printing. For example, the display 50 may be a touchscreen display allowing various menu options to be selected by a user, including font and size of text. Therefore, any scanned text and/or data may be optically character read or simply scanned as graphic data, and the printing process may print the optically character read material or the scanned graphic data, in accordance with various embodiments of the present invention.

When a user turns the device around and presses the distal activation button 81, the printing head 40 is activated (i.e., electrical power is provided to the printing head 40). This is accomplished by sending an electrical signal from the distal activation button 81 to the microprocessor and associated support circuitry 20. The microprocessor and associated support circuitry 20 receives and processes the signal and then, in response, switches electrical power from the power source 70 to the printing head 40, retrieves the stored information from the memory 25, and sends the stored information to the printing head 40. Next, when the user begins moving the device 10 (e.g., across a printable medium), the motion sensor (e.g., accelerometer) senses the movement and sends an electrical signal to the microprocessor and associated support circuitry 20 in response. The electrical signal is received and processed by the microprocessor and associated support circuitry 20 which then sends another electrical signal to the printing head 40 which directs the printing head 30 to begin printing the information.

When the user stops moving the device 10 (e.g., across the printable medium), the motion sensor senses the stopped motion and sends an electrical signal to the microprocessor and associated support circuitry 20 in response. The electrical signal is received and processed by the microprocessor and associated support circuitry 20 which then sends another electrical signal to the printing head 40 which directs the printing head 40 to stop printing. The user then releases the distal activation button 80 and, upon such releasing, an electrical signal is sent from the distal activation button 80 to the microprocessor and associated support circuitry 20. The electrical signal is received and processed by the microprocessor and associated support circuitry 20 which then, in response, removes electrical power from the printing head 40. The user can then easily view the printed information to verify that the desired information was properly printed.

The term “electrical signal”, as used herein, may be an analog signal (e.g., a DC voltage signal, an AC voltage signal, or a pulsed signal), a digital signal (e.g., a logic high or a logic low signal), or a data word of multiple binary data bits (e.g., 1's and 0's). Other embodiments having alternative internal operations are possible as well. For example, printing may stop automatically upon completion of printing all of the stored information, instead of upon stopping of the movement of the device 10. Also, the scanned information may be sent from the optical scanning head 30 to the microprocessor and associated support circuitry 20 in real time, instead of after releasing the proximal activation button 80. Again, if the printing head 30 is an inkjet print cartridge, an ink reservoir or insertable ink cartridge 45 is used to provide ink to the inkjet print cartridge.

Furthermore, in accordance with an embodiment of the present invention, the scanned information remains stored in the memory 25 until being overwritten upon subsequent scanning. Therefore, any scanned information may be printed multiple times. In accordance with an alternative embodiment of the printed information, the scanned information that is stored in memory 25 is erased from the memory 25 upon first printing of the stored information.

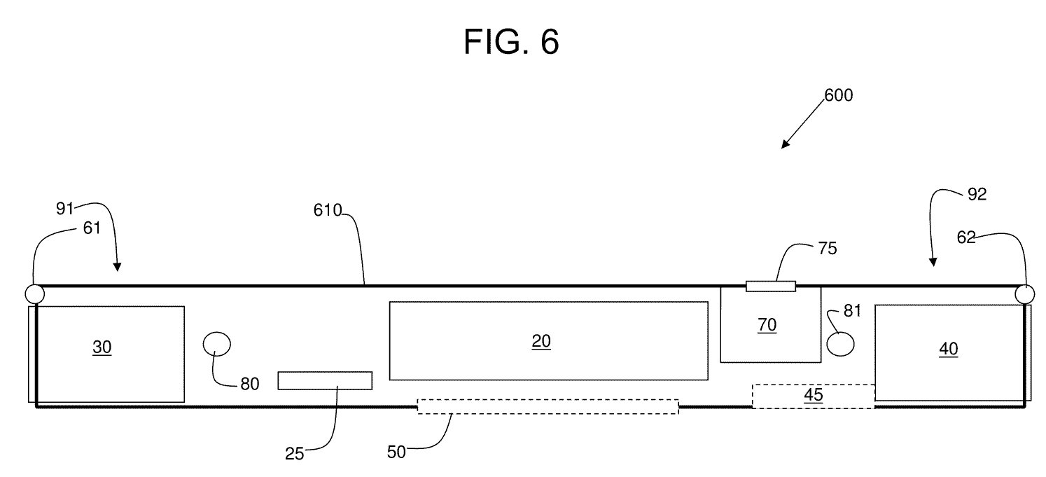

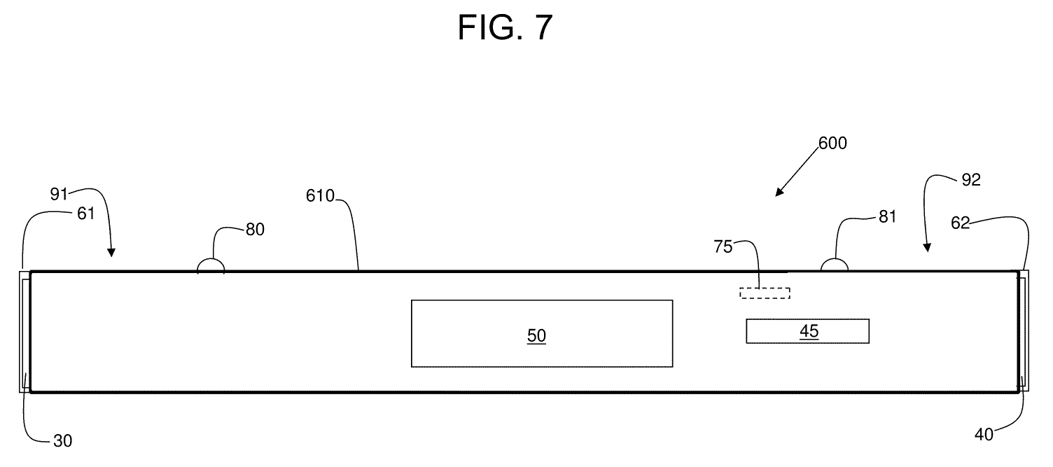

FIG. 6 illustrates a top view of a second example embodiment of a housing 610 of a hand-held device 600, and showing various elements or components integrated therewith. FIG. 7 illustrates a side view of the second example embodiment of the housing 610 of the hand-held device 600 of FIG. 6, and showing various integrated elements and components that are at least partially visible on the outside of the housing 610. The device 600 of FIG. 6 and FIG. 7 is very similar to the device 10 of FIG. 2 and FIG. 3 except that the housing 610 is not cylindrical but is a rectangular cuboid shape, and the motion sensor 60 (e.g., including an accelerometer) is replaced with a proximal position wheel 61 and a distal position wheel 62.

In accordance with an embodiment of the present invention, the proximal position wheel 61 is cylindrical in shape and is integrated at the proximal end of the device 600 adjacent to the optical scanning head 30. When a user moves the proximal end of the device 600 across a scannable medium, the cylindrical position wheel 61 rotates about an axis as it rolls across the surface of the scannable medium and outputs an electrical signal to the microprocessor and associated support circuitry 20 indicative of the motion. The output electrical signal is functionally used in a manner similar to the electrical signal output from motion sensor 60 of FIG. 2 during scanning as described above herein.

Similarly, in accordance with an embodiment of the present invention, the distal position wheel 62 is cylindrical in shape and is integrated at the distal end of the device 600 adjacent to the printing head 40. When a user moves the distal end of the device 600 across a printable medium, the cylindrical position wheel 62 rotates about an axis as it rolls across the surface of the printable medium and outputs an electrical signal to the microprocessor and associated support circuitry 20 indicative of the motion. The output electrical signal is functionally used in a manner similar to the electrical signal output from motion sensor 60 of FIG. 2 during printing as described above herein.

The position wheels 61 and 62 have to make contact with the respective scannable or printable media in order to be rotated and sense motion. Whereas, the motion sensor 60 of FIG. 1, having an accelerometer, will sense motion whether or not the proximal end or the distal end of the device 10 makes physical contact with the respective scannable or printable media. There may be advantages to using one type of motion sensor versus the other type of motion sensor, for example, depending on the scanning and printing applications.

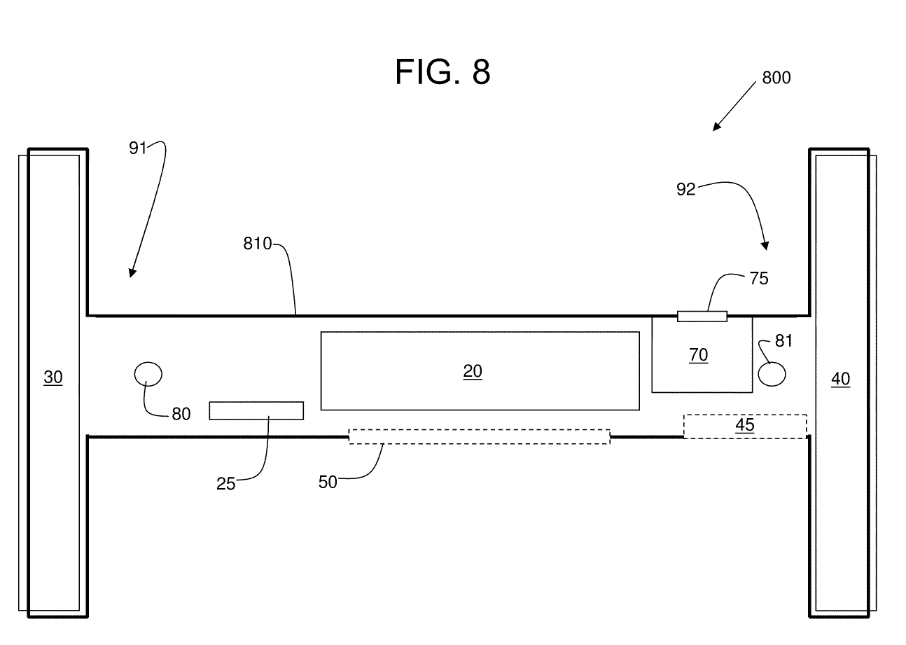

FIG. 8 illustrates a top view of a third example embodiment of a housing 810 of a hand-held device 800, and showing various elements or components integrated therewith. The hand-held device 800 of FIG. 8 is similar to the hand-held device 10 of FIG. 2 or the hand-held device 600 of FIG. 6, except that there is no motion sensor in the device 800, and the optical scanning head 30 and the printing head 40 (along with their respective housing portions at the proximal and distal end portions of the device 800) are elongated in a direction that is perpendicular to the elongation of the main body of the device 800 containing the other components as shown in FIG. 8. In the configuration of FIG. 8, the device 800 does not have to be moved across a scannable medium to read information, and does not have to be moved across a printable medium to print the scanned information. Instead, the optical scanning head 30 is positioned over the information to be scanned on the scannable medium and held there at that fixed position during scanning. The proximal activation button 80 is pressed and scanning commences, without moving the device 800. Similarly, the printing head 40 is positioned over printable medium and held there at that fixed position during printing. The distal activation button 81 is pressed and printing commences, without moving the device 800.

The device 800 of FIG. 8 may be simpler to use in some respects than the devices of FIG. 2 and FIG. 6, since the device 800 does not have to be moved across a medium during scanning or printing. However, the extent of information to be scanned or printed by the device 800 at any one time is limited by the extent of the optical scanning head 30 and the extent of the printing head 40, respectively. Whereas, the extent of information to be scanned or printed by the devices 10 and 600 of FIG. 2 and FIG. 6 are limited, instead, by the amount of electronic storage memory 25, which can be quite large.

In accordance with still a further embodiment of the present invention, a device may include the optical scanning head of FIG. 2 and the printing head of FIG. 8. In such an embodiment, scanning is accomplished by moving the proximal end of the device across the scannable medium, and printing is accomplished by fixedly positioning the distal end of the device onto the printable medium (i.e., a user simply holds the distal end of the device on the printable medium where the user desires to print). Such an embodiment may be easier for some users, where the scanned information is motion compensated and properly stitched together, allowing for relatively error-free scanning, and where the device does not have to be moved across the printable medium to print, allowing for relatively error-free printing.

In accordance with certain embodiments of the present invention, an identifying marker may be printed by the printing head of the hand-held device onto a printable medium as part of the printing process. The identifying marker encodes a device identifier, identifying the hand-held device, and/or a date indicating the date of printing. The identifying marker is stored in the electronic storage memory of the hand-held device. An electronic clock device may be integrated into the hand-held device and operatively connected to the microprocessor and associated support circuitry to keep track of the date.

In accordance with another embodiment of the present invention, the hand-held device provides the capability to scan and print an object (e.g., large text, multiple line text, or an image) having an extent that is larger than the extent of the optical scanning head and/or the printing head. This is accomplished by making several scanning passes over different portions of the object on the scannable medium, and then subsequently printing the object onto a printable medium by making several printing passes over different portions of the printable medium.

When scanning or printing an object having such a large extent via multiple passes, the user would rarely, if ever, achieve exactly parallel paths for the multiple passes over the target area having the correct alignment. In accordance with the embodiment, for scanning multiple passes across the scannable medium, the device includes a pattern matching algorithm run on the microprocessor and associated support circuitry to determine the information in the overlap region of successive scans and to correctly “stitch” together the successive scans and store in memory.

Similarly, in accordance with the embodiment, for printing multiple passes across the printable medium, the device includes an optical reader integrated into the printing end of the device. The optical reader is capable of detecting at least a portion of the object information from a previous print pass on the printable medium (e.g., a leading edge). Then using the pattern matching algorithm, the device is capable of determining and printing only the next portion to be printed based on the current printing path across the printable medium taken by the user. In accordance with a particular embodiment of the present invention, the optical reader on the printing end of the device is used for both scanning the scannable medium to initially capture the object information, and then optically reading the printable medium during printing. In such a particular embodiment, a separate optical scanning head on the opposite end of the device is not provided.

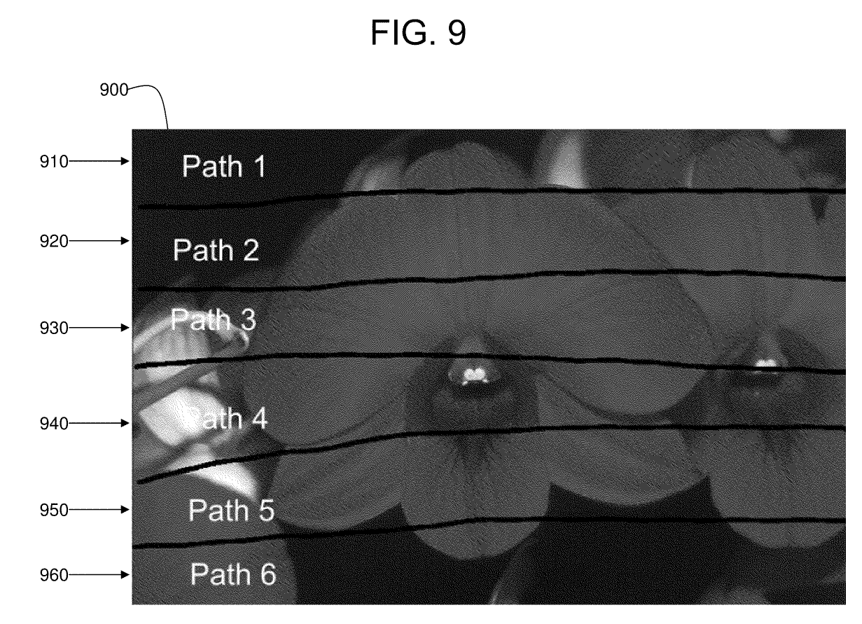

FIG. 9 illustrates an example of a printed image 900 resulting from multiple printing passes, in accordance with an embodiment of the present invention. FIG. 9 shows six different printing paths or passes 910-960 that were taken by the user. The device, using the optical reader and the pattern matching algorithm, determines the information to be printed in the successive areas of the printable medium for each printing pass such that the resultant image 900 is printed correctly, without any misalignment or shifting of the printed image data.

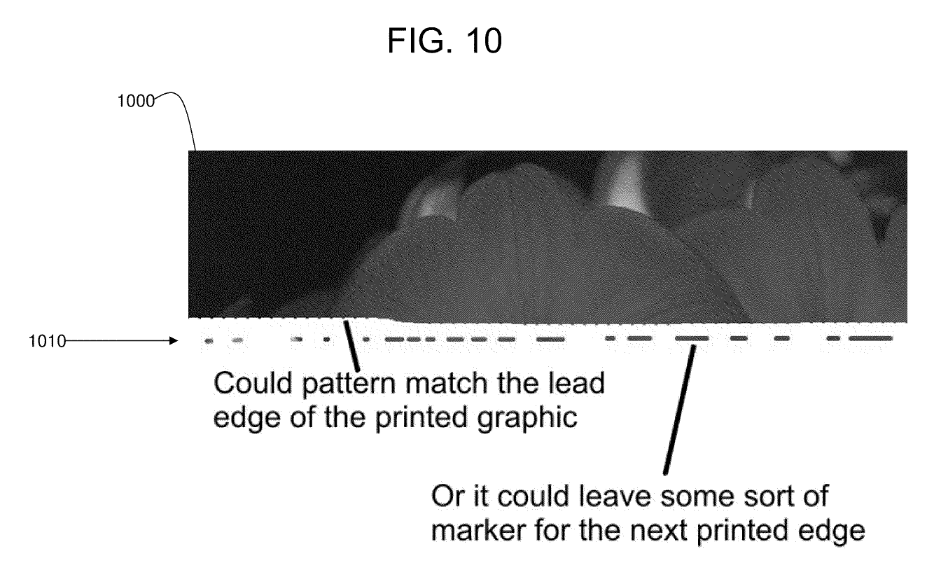

Alternatively, instead of using a pattern matching algorithm for detecting the leading edge of a portion of a printed object, a previous printing pass prints a recognizable pattern along with the object information for that pass. FIG. 10 illustrates an example of a portion of a printed image 1000 resulting from one or more printing passes and leaving a printed marker 1010 for a next printing pass, in accordance with an embodiment of the present invention. During the next printing pass, the optical reader on the printing end of the device detects the printed marker 1010 and uses the spatial position of the printed marker 1010 with respect to the printing head to determine where to correctly print the next portion of the image information during that next printing pass.

The capability to detect a printing marker may also be used, for example, to detect a signature line on a document. When the device is used to print a signature on the document, the device reads and determines the position of the signature line with respect to the printing head using the optical reader such that the printing head is directed to print the signature just above the signature line, even though the user may not move the device exactly parallel across the signature line.

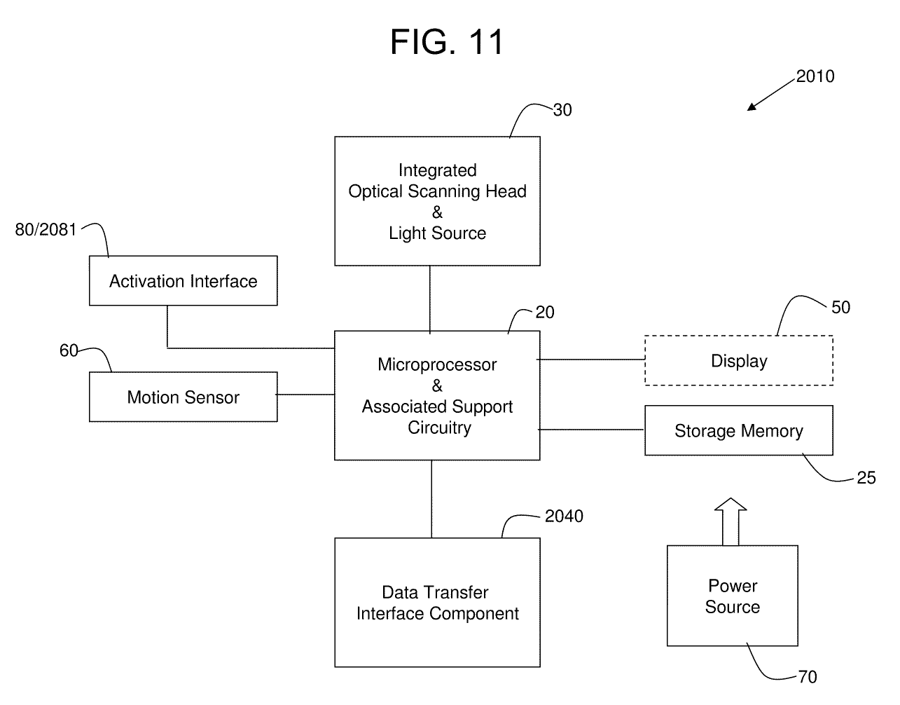

FIG. 11 illustrates a schematic block diagram of an embodiment of a hand-held device 2010 for scanning and subsequent data transfer. The device 2010 is used to scan displayed, printed, or written information from a scannable medium such as, for example, a page in a book or a printed form, and then subsequently transferring the scanned information into a data field of a software application program such as, for example, a medical records software application program, Microsoft® Office Word, or Internet Explorer®. As another example, the device 2010 may be used by an individual to scan his or her signature, and then subsequently transfer the scanned signature on a plurality of electronic documents to be signed by the individual. The device 2010 is capable of being held or gripped by a hand of a user. In certain embodiments, the device is capable of being gripped by a hand of a user in a manner similar to that of gripping a writing utensil. In accordance with an embodiment of the present invention, the device 2010 is held and moved in a manner similar to how a hi-liter marker is held and moved.

The device 2010 includes a microprocessor and associated support circuitry 20. The associated support circuitry portion of the microprocessor and associated support circuitry 20 may include, for example, display driver circuitry, user interface circuitry, control interface circuitry, a printed circuit board, and connecting wires, in accordance with various embodiments of the present invention. The device 2010 includes an optical scanning head 30 or, alternatively, an integrated optical scanning head and light source 30, operatively connected to the microprocessor and associated support circuitry 20. The device 2010 further includes a data transfer interface component 2040 operatively connected to the microprocessor and associated support circuitry 20. The device 2010 also includes a storage memory 25, a motion sensor 60, and an activation interface 80/2081 each operatively connected to the microprocessor and associated support circuitry 20. The device 2010 further includes an electrical power source 70. As an option, the device 2010 may include a display 50 (e.g., a liquid crystal display (LCD) or a light emitting diode (LED) display).

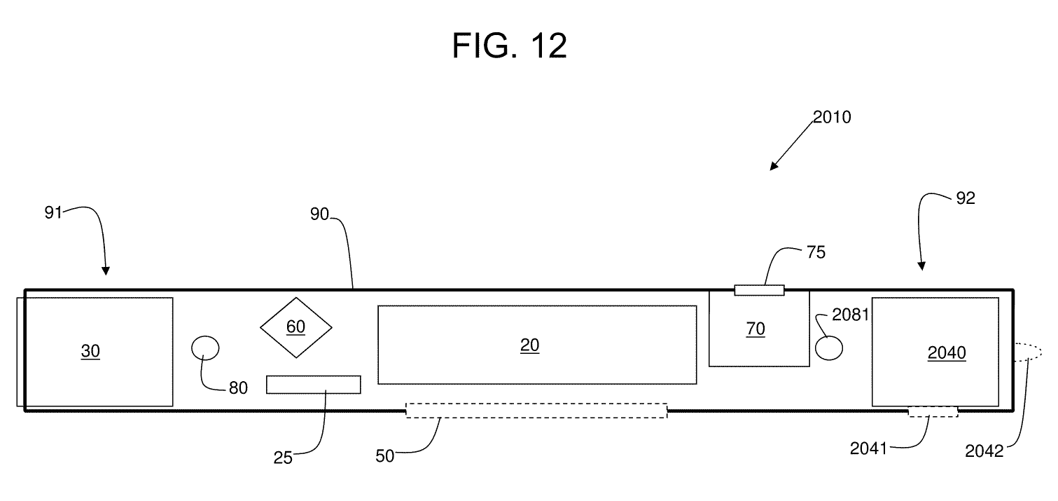

FIG. 12 illustrates a top view of an example embodiment of a housing 90 of the hand-held device 2010 of FIG. 11 and showing various elements or components integrated therewith. In accordance with an embodiment of the present invention, the housing 90 is elongated and is substantially cylindrical in shape. In accordance with another embodiment of the present invention, the housing 90 is elongated and substantially rectangular in shape (e.g., a rectangular cuboid). The optical scanning head 30 may be physically integrated into a proximal end portion 91 of the housing 90, and the data transfer interface component 2040 may be physically integrated into the housing 90, such as at a distal end portion 92 of the housing 90. Alternatively, the data transfer interface component 2040 may be physically integrated into a portion of the housing 90 between the proximal end portion 91 and the distal end portion 92.

The microprocessor and associated support circuitry 20 is physically integrated into an interior volume of the housing 90. Similarly, the motion sensor 60 is physically integrated into an interior volume of the housing 90. In accordance with an embodiment of the present invention, the motion sensor 60 includes an accelerometer. The electronic storage memory 25 is physically integrated into an interior volume of the housing 90. The display 50 is physically integrated into a side portion of the housing 90 and is operatively connected to the microprocessor and associated support circuitry 20. The display 50 is shown in dotted line to indicate that it is optional.

The power source 70 is physically integrated into an interior volume of the housing 90 and is operatively connected to various elements and components (e.g., the microprocessor and associated support circuitry 20, the optical scanning head 30, the data transfer interface component 2040, the storage memory 25, the motion sensor 60, and the display 50) of the hand-held device 2010 to provide electrical power to those various elements and components. In accordance with an embodiment of the present invention, the power source 70 includes a re-chargeable power pack having an electrical connector interface 75 allowing the power source 70 to be operatively connected to an external power charger. In accordance with another embodiment of the present invention, the power source 70 includes at least one replaceable battery. In accordance with still another alternative embodiment of the present invention, a power source 70 is not provided within the housing 90 and, instead, the device 2010 is capable of being plugged into an external electrical power source during use. For example, electrical power may be provided from a personal computer to the device 2010 via a USB connection.

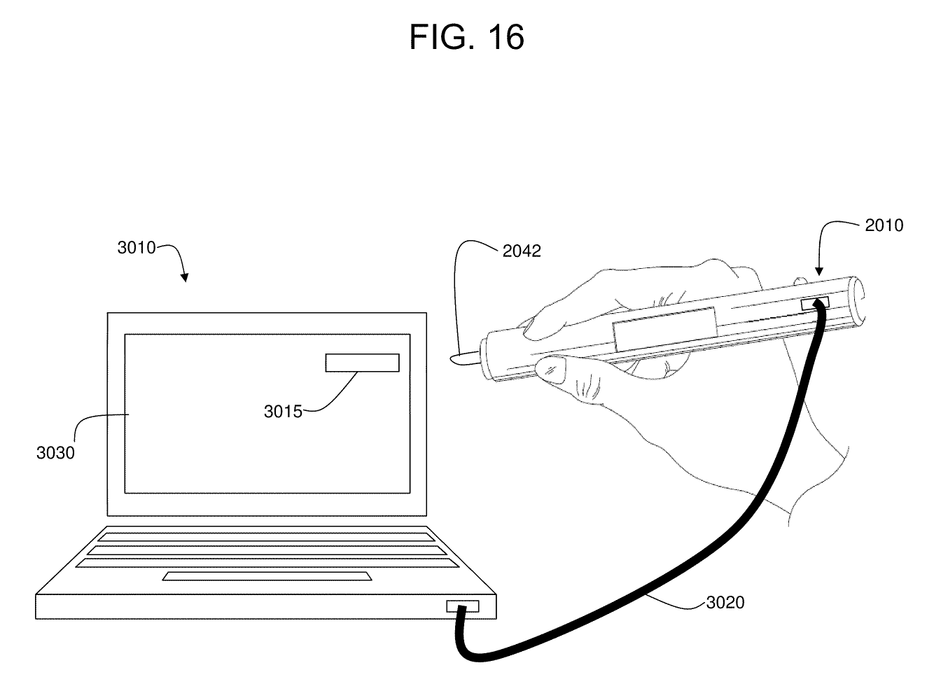

The data transfer interface component 2040 may be a wired or wireless component that allows the device 2010 to interact with a processor-based apparatus (e.g., a microprocessor-based device), such as a personal computer. An example of a wired component may be a universal serial bus (USB) component, while an example of a wireless component may be a short range radio transmission component (e.g., a Bluetooth® component). An interface connector 2041 such as, for example, a USB interface connector may optionally be provided to allow the data transfer interface component 2040 to interface to an external device such as, for example, a personal computer via a USB cable. The USB connector 2041 may be used to also provide electrical power to the various electrical components of the device 2010. After a connection between the device 2010 and the processor-based apparatus is established, either through a USB cable or wirelessly, the device 2010 may then transfer scanned information or information derived from the scanned information (e.g., via optical character reading) As used herein, the terms “scanned information (data)” and “stored information (data)” may refer generally to either of raw scanned information (data) or processed information (data) derived from scanned information (data). The transfer of scanned information may either occur automatically after the information is scanned, or the transfer of scanned information may occur after a user has initiated a “send” response, which will later be discussed in further detail. The data transfer interface component 2040 may allow the device 2010 to transfer scanned information, stored in the storage memory 25, to a data field of a software application program such as, for example, a medical records software application program, Microsoft® Office Word, or Internet Explorer® running on the processor-based apparatus (e.g., the personal computer 3010 of FIG. 16).

Additionally, the storage memory 25 may include firmware, software stored in ROM or PROM; essential programs that remain even when the system is turned off, that allows a processor-based apparatus (e.g., a personal computer) to automatically recognize the device 2010 and initiate proper recognition procedures. The storage memory 25 may also include a software program tailored specifically to the device 2010 that may be installed onto the processor-based apparatus to facilitate operations of the device 2010. The device's 2010 firmware or software program may be installed onto the processor-based apparatus after a connection is established between the device 2010 and the processor-based apparatus. When the storage memory 25 receives an electrical signal from the data transfer interface component 2040 that a connection has been made with a processor-based apparatus, the storage memory 25 will then send the appropriate firmware or software program to the processor-based apparatus through the data transfer interface component 2040, in accordance with an embodiment of the present invention.

The optical scanning head 30 includes a photosensor array which is a multiple color detection elevated pin photo diode active pixel sensor, in accordance with an embodiment of the present invention. In accordance with an alternative embodiment of the present invention, the photosensor array is a gray-scale detection elevated pin photo diode active pixel sensor. Other types of optical scanning heads are possible as well, in accordance with other embodiments of the present invention. The optical scanning head 30 may include an integrated light source (e.g., a light emitting diode (LED)). The light source is used to illuminate the scannable medium (e.g., a page of a book) while scanning with the optical scanning head 30. However, if the scannable medium is a fully lit computer screen, for example, the light source may not be needed.

The proximal activation interface 80 is located near the proximal end portion 91 of the housing 90 on the top of the housing 90 and is capable of activating the optical scanning head 30 when manually engaged by a user, and de-activating the optical scanning head 30 when manually disengaged by a user. For example, the proximal activation interface 80 may be a button that, when pressed and held down by an index finger of the user, activates the optical scanning head 30 and, when released by the user, de-activates the optical scanning head 30. Similarly, the distal activation interface 2081 is located near the distal end portion 92 of the housing 90 on the top of the housing 90 and is capable of activating the data transfer interface component 2040 when manually engaged by a user, and de-activating the data transfer interface component 2040 head when manually disengaged by a user. For example, the distal activation interface 2081 may be a button that, when pressed and held down by an index finger of the user, activates the data transfer interface component 2040 and, when released by the user, de-activates the data transfer interface component 2040. In accordance with an alternative embodiment of the present invention, the activation interfaces 80/2081 may be replaced with pressure sensitive switches integrated into the proximal and distal ends of the device 2010. When the proximal end of the device 2010 is pressed against a scannable medium, the optical scanning head 30 is activated. Similarly, when the distal end of the device 2010 is pressed against a medium, the data transfer interface component 2040 is activated. Pulling the proximal end or distal end of the device 2010 away from the medium de-activates the corresponding head. Such an alternative embodiment provides for automatic activation/de-activation of the optical scanning head 30 and the data transfer interface component 2040.

The term “activate”, as used herein with respect to certain embodiments, means to “turn on” to be ready for use. For example, in accordance with an embodiment of the present invention, activating the optical scanning head 30 turns on the optical scanning head 30 by applying electrical power to the optical scanning head 30 to ready it for scanning. However, the optical scanning head 30 does not actually begin to scan or capture information from a scannable medium until a user begins to move the device 2010, in accordance with an embodiment of the present invention. Such movement is detected by the motion sensor 60, for example. Furthermore, moving the device 2010 without first activating the optical scanning head 30 does not result in scanning or capturing information. Also, the term “de-activate”, as used herein with respect to certain embodiments, may mean to “turn off” by, for example, disconnecting electrical power. In accordance with certain alternative embodiments of the present invention, a motion sensor is not used to detect motion of the device 2010. Instead, activation of the optical scanning head 30 via the proximal activation interface 80 directly initiates the scanning or capturing of information from a scannable medium.

Activating the data transfer interface component 2040 initiates transferring of scanned data (or processed scanned data) from the data transfer interface component 2040 to a processor-based apparatus. However, the data transfer interface component 2040 does not actually transfer data to the processor-based apparatus until a user positions a displayed cursor in a displayed data field of a software application program running on the processor-based platform, in accordance with an embodiment of the present invention. As an alternative or option, the data transfer interface component 2040 does not actually transfer data to the processor-based platform until a user touches a stylus 2042 of the device 2010 to a displayed data field on a touchscreen display of the processor-based apparatus. In this way, the sensed position of the stylus on the touchscreen tells the processor-based apparatus which data field to populate with the transferred data.

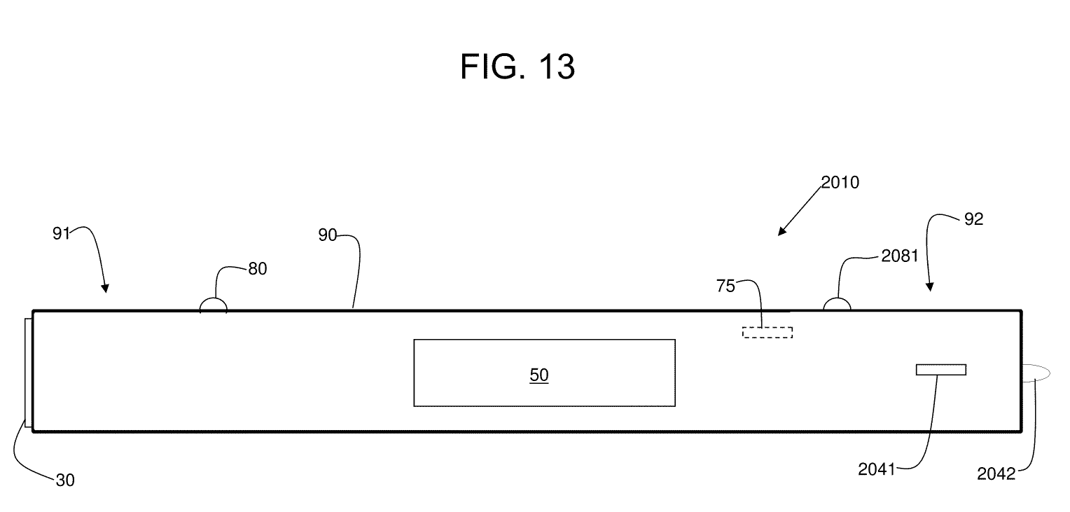

FIG. 13 illustrates a side view of the first example embodiment of the housing 90 of the hand-held device 2010 of FIG. 11 and FIG. 12 showing various integrated elements and components that are at least partially visible on the outside of the housing 90. The display 50 and the activation interfaces 80 and 2081 can be seen. An exposed contacting portion of the optical scanning head 30 is shown, along with an exposed optional stylus portion of the stylus 2042. The contacting portion of the optical scanning head 30 is used to make contact with, or at least closely approach, a scannable medium during operation. Similarly, the stylus 2042 may be used to make contact with, or at least closely approach, a touchscreen surface in association with a processor-based apparatus. The electrical connector 75 is shown in dotted line as being on the other side of the housing 90 (i.e., not visible from this side).

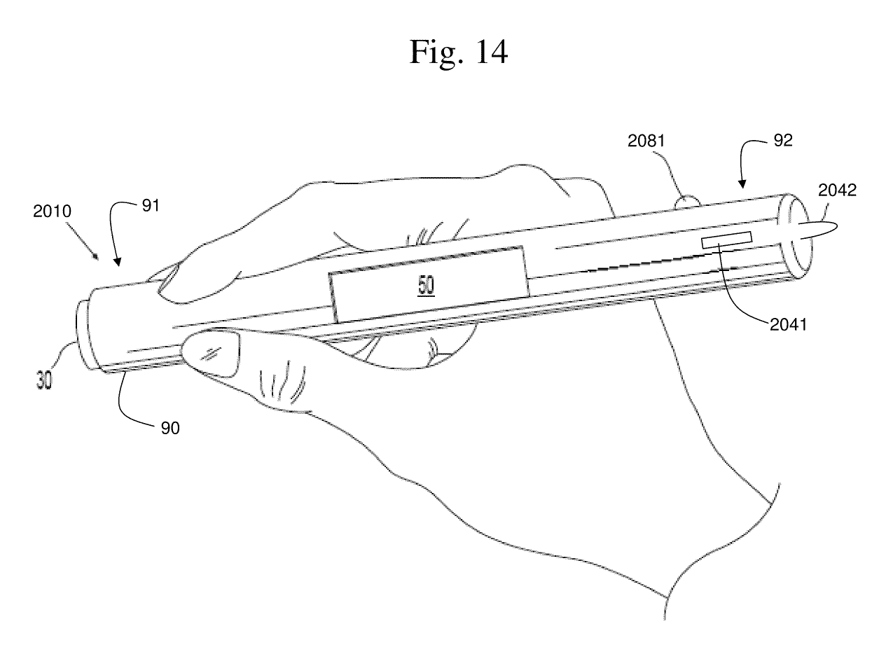

FIG. 14 illustrates a perspective view of the hand-held device 2010 of FIG. 13 being held by a user's hand. The hand-held device 2010 is shown as being substantially cylindrical in FIG. 14. As can be seen from FIG. 14, the hand-held device 2010 is held in a manner similar to that of holding a writing utensil or a hi-liter marker. Again, the display 50 can be seen. In FIG. 14, the display 50 is shown as being slightly recessed into the side of the housing 90. The proximal activation interface 80 is concealed by the index finger of the user's hand. However, the distal activation interface 2081 is clearly shown. Again, an exposed contacting portion of the optical scanning head 30 is shown, along with an exposed contacting portion of the stylus 2042. The user is holding the device 2010 in FIG. 14 so as to perform a scanning operation. By rotating the device 2010 around 180 degrees, the user would be holding the device so as to perform a data transfer operation.

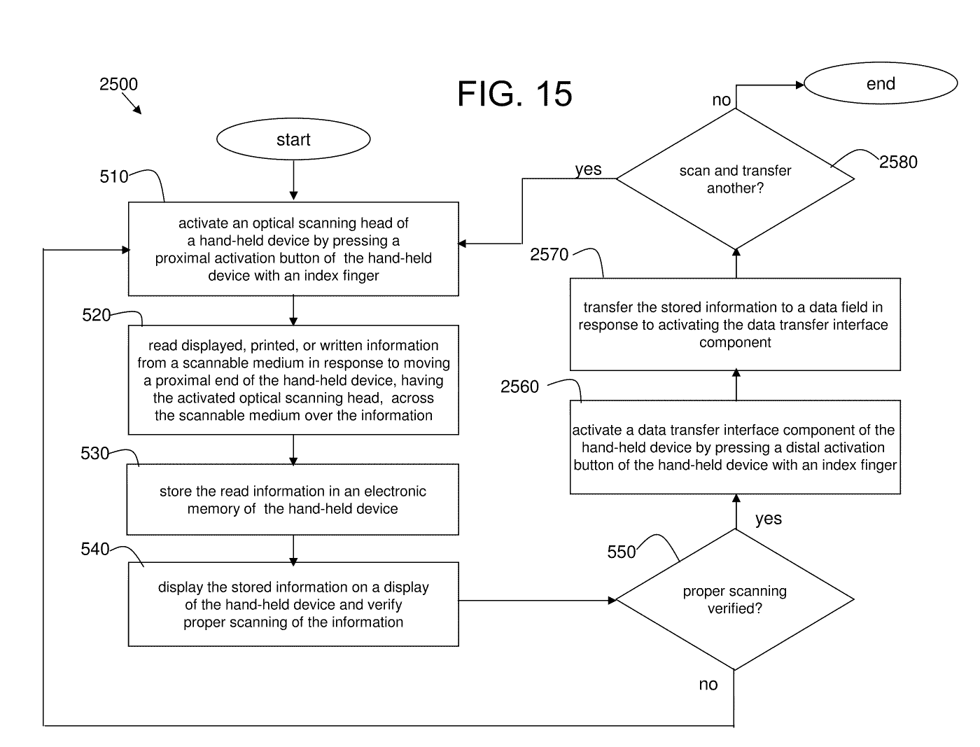

FIG. 15 is a flowchart of an embodiment of a method 2500 of using the hand-held device 2010 of FIG. 11 and FIG. 14. In step 510, an optical scanning head 30 of the hand-held device 2010 is activated by pressing a proximal activation button 80 of the hand-held device 2010 with an index finger. In step 520, information (e.g., displayed, printed, or written information) is read from a scannable medium in response to moving a proximal end 91 of the hand-held device 2010, having the activated optical scanning head 30, across the scannable medium over the information. In step 530, the read information is stored in an electronic memory 25 (e.g., a random access memory (RAM)) of the hand-held device 2010.

In step 540, the stored information is displayed on a display 50 of the hand-held device 2010 such that the user may verify that the desired information was scanned properly from the scannable medium. In step 550, if proper scanning is verified, then go to step 2560. If proper scanning is not verified, then go back to step 510 to start over. In step 2560, a data transfer interface component 2040 of the hand-held device 2010 is activated by pressing a distal activation button 2081 of the hand-held device 2010 with an index finger. In step 2570, the stored information is transferred to a data field in response to activating the data transfer interface component 2040. In step 2580, if it is desired to scan and transfer another displayed, printed, or written information, then go back to step 510, otherwise, end. The stored information may be raw scanned data or processed data derived from the raw scanned data.

FIG. 16 illustrates an embodiment of the handheld device 2010 interfacing to a personal computer 3010. A USB cable 3020 connects the device 2010 to the personal computer 3010 as discussed herein. A user is shown positioning the stylus 2042 of the device 2010 over a data field 3015 displayed on a touchscreen display 3030 of the personal computer 3010. The embodiment of the device 2010 shown in FIG. 16 is a little different than the embodiment of the device 2010 shown in FIG. 14. For example, the USB connector is shown near the proximal end portion of the device 2010 in FIG. 16, instead of near the distal end as in FIG. 14. Other differences are possible as well, in accordance with other embodiments.

As can be seen from FIGS. 14-16, the device 2010 is relatively easy to use. The device 2010 may be held a first way by a user to scan (i.e., read in) information, and the device may be held a second way to transfer that information. As an example, to scan, a user positions the proximal end (having the optical scanning head 30) at the beginning of a text phrase on a scannable medium to be optically scanned. The user activates the optical scanning head 30 by pressing the proximal activation button 80. Then the user moves the proximal end of the device 2010 across the text phrase on the scannable medium, scanning (i.e., reading in) the text phrase. The initiation of the movement of the device 2010, while the proximal activation button 80 is pressed, causes the optical scanning head 30 to actively begin reading. When the user stops moving the device 2010 upon reaching the end of the text phrase, the optical scanning head 30 stops reading. At this point, the user releases the proximal activation button 80 and the scanned information is stored in memory 25 and displayed on the display 50. The user may view the displayed text phrase on the display 50 to verify that the text phrase was scanned correctly. If not scanned correctly, the user may repeat the scanning process, trying to move the device 2010 across the text phrase in a more accurate or uniform manner, and/or at a different speed, to facilitate proper scanning. Becoming accomplished at properly moving the hand-held device 2010 to scan may take some practice on the part of the user.

Continuing with the example, to transfer the scanned text phrase, a user activates the data transfer interface component 2040 by pressing the distal activation button 2081. Pressing the distal activation button 2081 causes the data transfer interface component 2040 to actively begin transferring (assuming that the user has positioned a displayed cursor of the receiving processor-based apparatus in a displayed data field, or the user has positioned the stylus 2042 at the displayed data field on a touchscreen display of the processor-based apparatus). When the text phrase has been entirely transferred, the data transfer interface component 2040 stops transferring. At this point, the user releases the distal activation button 2081. The user may view the transferred text phrase in the data field to verify that the text phrase was transferred correctly. If the text phrase was not transferred correctly, the user may repeat the transferring process by pressing the distal activation button 2081 again.

The internal operation of the device 2010 is performed as follows, in accordance with an embodiment of the present invention. When a user presses the proximal activation button 80, the optical scanning head 30 (and light source, if present) is activated (i.e., electrical power is provided to the optical scanning head 30). This is accomplished by sending an electrical signal from the proximal activation button 80 to the microprocessor and associated support circuitry 20. The microprocessor and associated support circuitry 20 receives and processes the signal and then switches electrical power from the power source 70 to the optical scanning head 30 in response. Next, when the user begins moving the device 2010 (e.g., across a scannable medium), the motion sensor (e.g., accelerometer) senses the movement and sends an electrical signal to the microprocessor and associated support circuitry 20 in response. The electrical signal is received and processed by the microprocessor and associated support circuitry 20 which then sends another electrical signal to the optical scanning head 30 which directs the optical scanning head 30 to begin capturing (i.e., begin reading).

When the user stops moving the device 2010 (e.g., across the scannable medium), the motion sensor senses the stopped motion and sends an electrical signal to the microprocessor and associated support circuitry 20 in response. The electrical signal is received and processed by the microprocessor and associated support circuitry 20 which then sends another electrical signal to the optical scanning head 30 which directs the optical scanning head 30 to stop capturing (i.e., stop reading). The user then releases the proximal activation button 80 and, upon such releasing, an electrical signal is sent from the proximal activation button 80 to the microprocessor and associated support circuitry 20. The electrical signal is received and processed by the microprocessor and associated support circuitry 20 which then, in response, receives and processes the captured information (i.e., the read data) from the optical scanning head 30, proceeds to store the processed information in the electronic storage memory 25, proceeds to send the stored information to the display 50 to display the information, and then powers down the optical scanning head 30. While still holding the device 2010, the user can easily view the displayed information to verify that the desired information was properly scanned and captured. The resultant transferred information, as a result of subsequent transferring, will appear essentially the same as the displayed information, on a pixel-by-pixel basis or, if optically character read, the transferred information will appear in a font and size defined for the receiving data field in the software application program as discussed below.

In accordance with an embodiment of the present invention, successive frames of scanned information (acquired during the scanning process as the proximal end of the device is moved across the scannable medium) are processed by the microprocessor and associated supporting circuitry 20, before displaying, to motion compensate the successive frames and electronically “stitch” the frames together to correctly represent the information being scanned. In accordance with another embodiment of the present invention, the microprocessor and associated supporting circuitry 20 further performs an optical character reading (OCR) operation on the scanned and motion compensated information if the information is in text form. Furthermore, the font and size of the OCR'd information may be changed to that of a user-selected font and size by the microprocessor and associated supporting circuitry 20 before displaying and transferring. For example, the display 50 may be a touchscreen display allowing various menu options to be selected by a user, including font and size of text. Therefore, any scanned text and/or data may be optically character read or simply scanned as graphic data, and the transferring process may transfer the optically character read material or the scanned graphic data, in accordance with various embodiments of the present invention.

When a user turns the device around and presses the distal activation button 2081, the data transfer interface component 2040 is activated. This is accomplished by sending an electrical signal from the distal activation button 2081 to the microprocessor and associated support circuitry 20. The microprocessor and associated support circuitry 20 receives and processes the signal which then sends another electrical signal to the data transfer interface component 2040 which directs the data transfer interface component 2040 to begin transferring the information.

The distal activation button 2081 may also be utilized in a variety of modes. After the data transfer interface component 2040 receives the stored information from the storage memory 25, the data transfer interface component 2040 may either automatically begin transferring the stored information or the data transfer interface component 2040 may begin transferring the stored information after the distal activation button 2081 has been pressed. After the stored information is transferred, the user may then release the distal activation button 2081 and, upon such releasing, an electrical signal is sent from the distal activation button 2081 to the microprocessor and associated support circuitry 20. The electrical signal is received and processed by the microprocessor and associated support circuitry 20 which then, in response, stops the transfer of data from the data transfer interface component 2040. The user can then easily view the transferred information in the associated data field on the display of the processor-based apparatus to verify that the desired information was properly transferred.

The term “electrical signal”, as used herein, may be an analog signal (e.g., a DC voltage signal, an AC voltage signal, or a pulsed signal), a digital signal (e.g., a logic high or a logic low signal), or a data word of multiple binary data bits (e.g., 1's and 0's). Other embodiments having alternative internal operations are possible as well. Also, the scanned information may be sent from the optical scanning head 30 to the microprocessor and associated support circuitry 20 in real time, instead of after releasing the proximal activation button 80.

Furthermore, in accordance with an embodiment of the present invention, the scanned information remains stored in the memory 25 until being overwritten upon subsequent scanning. Therefore, any scanned information may be transferred multiple times. In accordance with an alternative embodiment of the present invention, the scanned information that is stored in memory 25 is erased from the memory 25 upon first transferring of the stored information.

In accordance with an alternative embodiment of the present invention, in a similar manner to that shown in FIG. 6 and FIG. 7, the motion sensor 60 (e.g., including an accelerometer) may be replaced with a proximal position wheel 61. Also, in accordance with another alternative embodiment of the present invention, in a similar manner to that shown in FIG. 8, there is no motion sensor in the device 2010, and the optical scanning head 30 (along with the respective housing portion at the proximal end portion of the device 2010) is elongated in a direction that is perpendicular to the elongation of the main body of the device 2010 containing the other components. In such a configuration, the device 2010 does not have to be moved across a scannable medium to read information. Instead, the optical scanning head 30 is positioned over the information to be scanned on the scannable medium and held there at that fixed position during scanning. The proximal activation button 80 is pressed and scanning commences, without moving the device 2010.

In summary, a hand-held device for scanning and subsequent transferring is disclosed. The hand-held device has an optical scanning head integrated into a proximal end portion of a housing of the device, and a data transfer interface component integrated into the housing of the device. Displayed, printed, or written information may be read from a scannable medium by manually moving (or fixedly positioning) a proximal end of the hand-held device across (or on) the scannable medium over the information. The read information is stored within the hand-held device, and the stored information may be transferred by the data transfer interface component into a data field of a software application program by manually positioning a stylus of the hand-held device (or a displayed cursor) at the data field of a touchscreen surface in association with a processor-based application and pressing a distal activation button, or in real time following completion of scanned information. The transfer of data may be accomplished via wired means or via wireless means, in accordance with various embodiments of the present invention.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiment disclosed, but that the claimed subject matter will include all embodiments falling within the scope of the appended claims.

What is claimed is:

1. A hand-held device for scanning and subsequent transfer, said hand-held device comprising:
(a) an elongated housing having a proximal end portion and a distal end portion and capable of being gripped by a hand of a user;
(b) a microprocessor and associated support circuitry physically integrated into an interior volume of said housing;
(c) an optical scanning head physically integrated into said proximal end portion of said housing and operatively connected to said microprocessor and associated support circuitry;
(d) a data transfer interface component physically integrated into said interior volume of said housing and operatively connected to said microprocessor and associated support circuitry; and
(e) an electronic storage memory physically integrated into an interior volume of said housing and operatively connected to said microprocessor and associated support circuitry.

2. The hand-held device of claim 1 further comprising a power source physically integrated into an interior volume of said housing and operatively connected to various elements of said hand-held device to provide electrical power to various elements of said hand-held device.

3. The hand-held device of claim 1 further comprising at least one motion sensor operatively connected to said microprocessor and associated support circuitry.

4. The hand-held device of claim 3 wherein said at least one motion sensor comprises an accelerometer physically integrated into an interior volume of said housing.

5. The hand-held device of claim 3 wherein said at least one motion sensor comprises a position wheel physically integrated at said proximal end portion of said housing.

6. The hand-held device of claim 3 wherein said at least one motion sensor comprises a position wheel physically integrated at said distal end portion of said housing.

7. The hand-held device of claim 1 further comprising a display physically integrated into a side portion of said housing and operatively connected to said microprocessor and associated support circuitry.

8. The hand-held device of claim 1 wherein said optical scanning head comprises a photosensor array.

9. The hand-held device of claim 8 wherein said photosensor array comprises a multiple color detection elevated pin photo diode active pixel sensor.

10. The hand-held device of claim 2 wherein said power source includes a re-chargeable power pack capable of operatively interfacing with an external power charger.

11. The hand-held device of claim 2 wherein said power source includes at least one replaceable battery.

12. The hand-held device of claim 1 further comprising a light source physically integrated at said proximal end portion of said housing and operatively connected to said microprocessor and associated support circuitry.

13. The hand-held device of claim 12 wherein said light source includes a light emitting diode (LED).

14. The hand-held device of claim 1 further comprising a proximal activation interface operatively connected to said microprocessor and associated support circuitry and capable of activating said optical scanning head when engaged by a user and de-activating said optical scanning head when disengaged by said user.

15. The hand-held device of claim 1 wherein said data transfer interface component includes a wired connector.

16. The hand-held device of claim 15 wherein said wired connector is a universal serial bus connector port.

17. The hand-held device of claim 1 wherein said data transfer interface component includes a wireless interfacing circuit.

18. The hand-held device of claim 17 wherein said wireless interfacing circuit is capable of transmitting a short range radio transmission for data transfer.

19. The hand-held device of claim 1 wherein said hand-held device is capable of interacting with a touchscreen surface.

20. The hand-held device of claim 19 wherein said interacting with a touchscreen surface includes transmitting scanned information into a data field selected by said hand-held device.

21. The hand-held device of claim 19 wherein said interacting with a touchscreen surface includes the automatic transmission of scanned information into a data field selected by said hand-held device as the information is scanned.

22. The hand-held device of claim 1 wherein said data transfer interface component automatically transmits scanned information immediately after said optical scanning head is deactivated by a user.

23. The hand-held device of claim 1 wherein said hand-held device further comprises a distal activation button that is physically integrated into a side portion of said housing and operatively connected to said microprocessor and associated support circuitry and capable of activating said data transfer interface component when engaged by a user and de-activating said data transfer interface component when disengaged by said user.

24. The hand-hand device of claim 23 wherein said distal activation button initiates transmission of scanned information to a data field selected by a user.

25. The hand-held device of claim 24 wherein said data field selected by a user includes a data field in which a cursor is positioned.

26. A hand-held apparatus capable of being gripped by a hand of a user, said apparatus comprising:
(a) means for reading displayed, printed, or written information from a scannable medium in response to manually moving a proximal end of said hand-held apparatus across said scannable medium over said information;
(b) means for storing said read information in said hand-held apparatus; and
(c) means for transferring said stored information into a data field of a software application program running on a processor-based apparatus in response to pressing a distal activation button.

27. The apparatus of claim 26 further comprising means for activating said means for reading.

28. The apparatus of claim 27 further comprising means for de-activating said means for reading.

29. The apparatus of claim 26 further comprising means for illuminating said scannable medium.

30. The apparatus of claim 29 further comprising means for activating said means for reading and said means for illuminating.

31. The apparatus of claim 30 further comprising means for de-activating said means for reading and said means for illuminating.

32. The apparatus of claim 26 further comprising means for activating said means for transferring.

33. The apparatus of claim 32 further comprising means for de-activating said means for transferring.

34. The apparatus of claim 26 further comprising means for displaying said stored information on said hand-held apparatus.

35. The apparatus of claim 26 further comprising means for electronically charging said hand-held apparatus.

36. The apparatus of claim 26 further comprising means for replacing at least one power source of said hand-held apparatus.

37. The apparatus of claim 26 further comprising means for connecting said hand-held apparatus to an external electrical power source.

38. The apparatus of claim 26 further comprising means for processing said read information to motion compensate and stitch together successive captured frames of said read information.

39. The apparatus of claim 26 further comprising means for processing said read information to perform an optical character reading operation on said read information to form optically character read information.

40. The apparatus of claim 39 further comprising means for changing a font and size of said optically character read information.

41. A hand-held apparatus capable of being gripped by a hand of a user, said apparatus comprising:
(a) means for reading displayed, printed, or written information from a scannable medium in response to manually positioning a proximal end of said hand-held apparatus over said information on said scannable medium at a fixed position;
(b) means for storing said read information in said hand-held apparatus; and
(c) means for transferring said stored information into a data field of a software application program running on a processor-based apparatus in response to manually positioning a distal end of said hand-held apparatus onto a touchscreen surface in association with said processor-based apparatus at a fixed position corresponding to said data field.

42. The apparatus of claim 41 further comprising means for activating said means for reading.

43. The apparatus of claim 42 further comprising means for de-activating said means for reading.

44. The apparatus of claim 41 further comprising means for illuminating said scannable medium.

45. The apparatus of claim 44 further comprising means for activating said means for reading and said means for illuminating.

46. The apparatus of claim 45 further comprising means for de-activating said means for reading and said means for illuminating.

47. The apparatus of claim 47 further comprising means for activating said means for transferring.

48. The apparatus of claim 47 further comprising means for de-activating said means for transferring.

49. The apparatus of claim 41 further comprising means for displaying said stored information on said hand-held apparatus.

50. The apparatus of claim 41 further comprising means for electronically charging said hand-held apparatus.

51. The apparatus of claim 41 further comprising means for replacing at least one power source of said hand-held apparatus.

52. The apparatus of claim 41 further comprising means for connecting said hand-held apparatus to an external electrical power source.

53. The apparatus of claim 41 further comprising means for processing said read information to perform an optical character reading operation on said read information to form optically character read information.

54. The apparatus of claim 53 further comprising means for changing a font and size of said optically character read information.
